(19) United States
(12) Patent Application Publication
(10) Pub. No.: US 2025/0315724 A1
(43) Pub. Date: Oct. 9, 2025

(54) INTERPRETABLE AND SECURE CLIENT SELECTION APPROACH BASED ON PREDICTION CONFIDENCES FOR EFFICIENT FEDERATED LEARNING

(71) Applicant: Dell Products L.P., Round Rock, TX (US)

(72) Inventors: Jonathan Mendes De Almeida, Brasília (BR); Maira Beatriz Hernandez Moran, Rio de Janeiro (BR); Thais Luca Marques de Almeida, São Gonçalo (BR); Yanexis Pupo Toledo, Niterói (BR)

(21) Appl. No.: 18/630,593

(22) Filed: Apr. 9, 2024

(51) Int. Cl. G06N 20/00

(52) U.S. Cl. CPC G06N 20/00

(57) ABSTRACT

A client selection approach based on prediction confidences for federated learning is disclosed. When performing a training round, each of the clients generates an update to a local model being trained. The update includes an average confidence score for the training round based on an output of a pre-argmax layer of the local model. The central server selects a subset of the federation clients based on the average confidence scores. The model updates from selected clients are aggregated and used to generate a new or updated global model. The new global model is distributed to all clients for a next training round.

### TECHNOLOGICAL FIELD OF THE DISCLOSURE

Embodiments disclosed herein generally relate to federated learning and to machine learning. More particularly, at least some embodiments relate to systems, hardware, software, computer-readable media, and methods for selecting clients to participate in training rounds of federated learning systems.

### BACKGROUND

Federated learning is an example of a distributed machine learning framework and is generally configured to strengthen data privacy and security by training a model locally and aggregating updates from the local models into a new global model without ever sharing the local data of the clients of the federated learning system. Even though federated learning approaches have some of the same goals of traditional machine learning solutions, federated learning executions differ significantly in scale due to the possibility that a large number of clients (nodes) may participate.

Consequently, the data characteristics and device capabilities can vary widely among clients in the federation. However, properly selecting clients, during global model aggregation, is considered an NP-hard problem. Further, only some of the client updates are used in a global model aggregation operation. As a result, federated learning solutions often select participants to participate in the global model aggregation randomly. Even though randomly selected clients are suitable for some cases, randomly selecting the clients to participate in the model aggregation operation can negatively impact the efficiency of training the federated learning model in terms of performance/convergence time and may also lead to biased testing sets.

In this context, an interpretable/explainable and efficient client selection process would allow the behavior of federated learning model to be better understood. For example, the selection could be tracked back to the distributed training datasets. An interpretable/explainable client selection process would allow clients who hold high-quality data and may be more important t to model aggregation to be selected. However, explainable/interpretable federated learning solutions must deal with data privacy and resource constraints in terms of local computation and communication power, which makes this task very challenging.

Generally, explainable federated learning solutions often adapt traditional Explainable AI (XAI) solutions, such as SHAP (Shapley Additive Explanations). These solutions add costly mechanisms in order to securely provide interpretability for the decision-making procedures (such as client selection) in federated learning approaches. Additionally, some solutions require the execution of multiple model retraining rounds, which can be extremely costly (and impeditive) for several federated learning scenarios, such as in Internet of Things (IoT) use cases, where there are strict computation and energy consumption constraints.

Consequently, there is a need for low cost (in terms of computational resource usage and energy consumption) mechanisms that are able to deal with the trade-off between computing explanations and computation/communication performance, such as decision-making mechanisms that do not require much additional computational overhead.

Proper client selection can directly impact the performance of the federated learning model because the quality of clients' local data can determine the effectiveness of their local models and consequently the performance of the global model. For instance, clients with noisy data will probably negatively impact the performance of the federated learning model. In many instances, randomly selecting clients to participate in the model aggregation can slow model convergence, and result in inaccurate predictions and/or undesired biases.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIGS. 1A and 1B disclose aspects of phases of federated learning that include explainable and/or interpretable client selection operations to select clients to participate in global model aggregation operations;

FIG. 2 discloses aspects of determining prediction confidence values in local model training rounds;

FIGS. 3A, 3B, and 3C discloses aspects of phases of a federated learning training round in which updates to the global model are aggregated from selected clients;

FIG. 4 discloses aspects of model loss using test data with a client selection approach in accordance with embodiments of the invention; and

FIG. 5 discloses aspects of a computing device, system, or entity.

### DETAILED DESCRIPTION OF SOME EXAMPLE EMBODIMENTS

Embodiments disclosed herein generally relate to federated learning systems and machine learning. More particularly, at least some embodiments relate to systems, hardware, software, computer-readable media, and methods for securely and interpretably selecting clients to participate in federated learning including global model aggregation operations.

Federated learning is an example of a distributed machine learning framework. Federated learning promotes data privacy and security by training instances of a global model that has been distributed to a set of clients. The clients train their local model and send model updates to a central node that aggregates the updates (global model aggregation) to generate an updated or new global model. This iterative process is performed, for example, until the model converges or other stopping criteria is satisfied. This allows a global model to be trained without requiring the clients to share their specific local data.

In federated learning, the number of clients participating (e.g., training a local model) can be very large. However, only some of the client updates are selected and used to generate the next version of the global model. Embodiments of the invention relate to an interpretable client selection approach that is configured to improve the global model convergence speed. In one example, this is achieved by selecting clients to participate in the model aggregation process based on prediction confidences associated with each client in the federation.

This process may include multiple phases. A first phase of embodiments of the invention is performed at the edge. In phase one (1), all participating clients receive a federated learning model from a central server. The clients perform training and inference using their local data and a model update may be generated at each of the clients. Next, each of the clients sends their local model update to the central server along with an average prediction confidence.

In phase two (2), which is performed on the cloud side or at the central server, the central server receives the average prediction confidences and local updates (e.g., model weights) from each of the clients in the federation. The central server then selects a subset of the clients to participate in the current global model aggregation procedure. The selection of clients is based, in one example, on the prediction confidence values received from the clients.

In phase three (3), which is also performed at the cloud side, the central server aggregates the updates from the selected clients (e.g., using FedAVG) to generate a new (or updated) global model. The central server broadcasts the new global model to all clients in the federation and the federated learning operation proceeds to the next training round of federated learning.

Embodiments of the invention provide a lightweight and interpretable client selection mechanism for federated learning systems that is based on prediction confidences. Embodiments of the invention can be implemented without compromising computations of communications of the federated system or of the clients. Advantageously, the performance of the global model is improved and may converge more quickly by considering clients whose local models are more reliable. Advantageously, the use of updates from inaccurate clients (e.g., poor/less diverse local data) can be prevented or reduced. Thus, the quality of the global model is less likely to be impaired and the convergence of the global model is accelerated. This advantageously reduces computational and communication overhead.

The manner in which the clients selected to participate in the aggregation portion of federated learning enables interpretability and considers the uncertainty of the local client models. For example, in real-world use cases, some clients in the federation have more data and/or access to more diverse data than other clients and, consequently, local models with better performance. In this context, the client prediction confidences can provide a measure of uncertainty in local training data without compromising the clients' privacy, which is relevant when dealing with such heterogeneous data distributions across federated clients. This encourages clients to join the federation and improves the generalization of the global model.

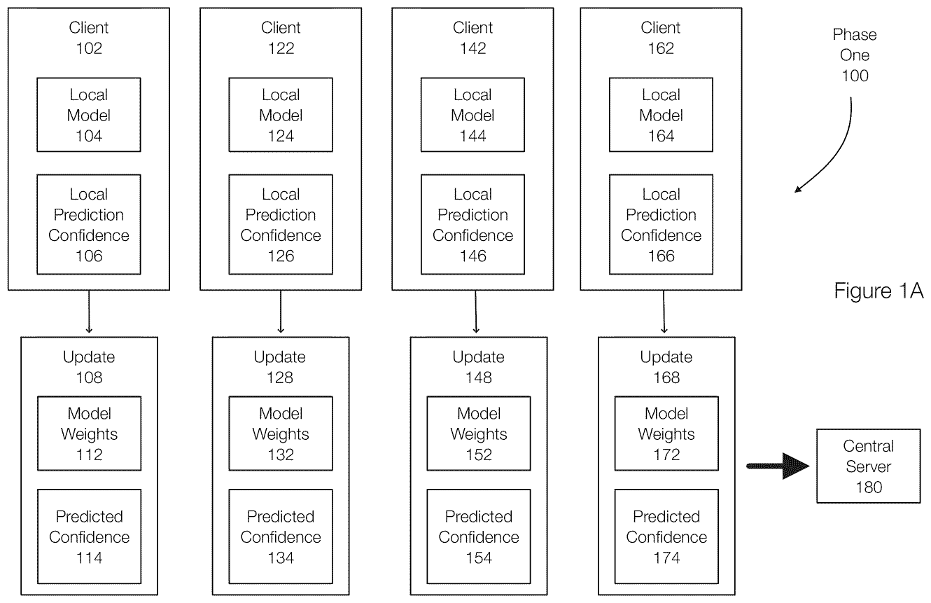

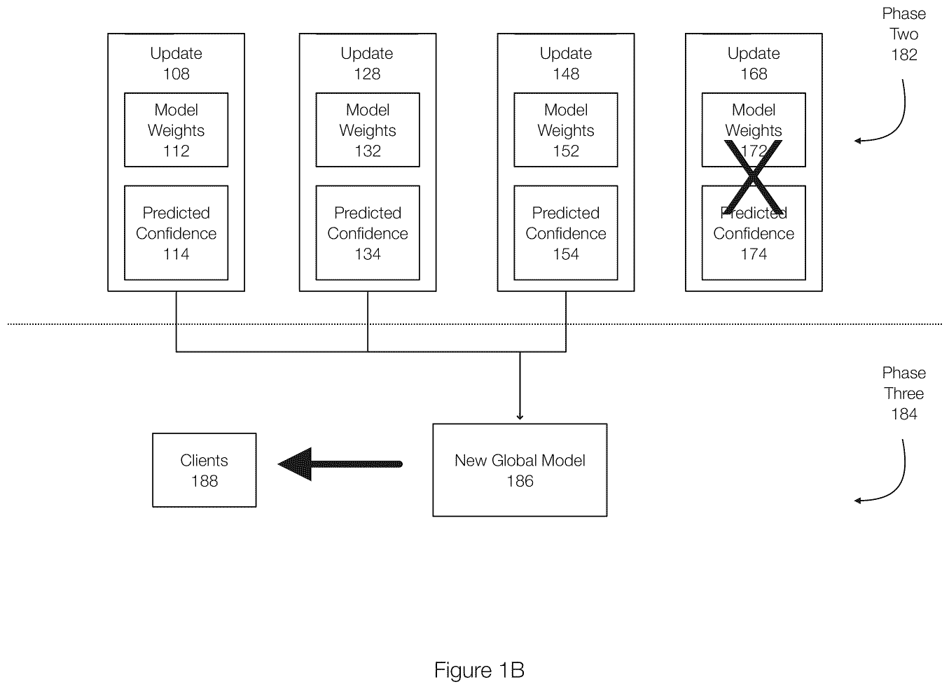

FIGS. 1A and 1B disclose aspects of federated learning that include explainable and/or interpretable client selection operations. FIGS. 1A and 1B illustrate phases of federated learning that includes selecting specific clients, whose updates are used in global model aggregation operations. More specifically, the local updates from selected clients are aggregated and used to generate a new global model (e.g., update an existing global model) that is then distributed back to the clients for further training if necessary. Federated learning is generally performed in training rounds or iterations until the global model converges (e.g., changes are less than a threshold or error is less than a threshold) or when other stopping criterion is satisfied (e.g., specified number of rounds).

FIG. 1A illustrates phase one that is performed at the edge or at the clients. FIG. 1A illustrates clients 102, 122, 142, and 162 that are representative members of a federated learning system. FIG. 1A illustrates four clients for ease of explanation. However, the number of federated clients can be very large. Further the federated clients may be geographically distributed.

The clients 102, 122, 142, and 162 are associated with, respectively, local models 104, 124, 144, and 164. At the beginning of each training round, in one example, the local models 104, 124, 144, and 164 are identical and are a copy of a global model that was received from a central server 180. The local models 104, 124, 144, and 164 are trained using local data. As a result, the weights of the models 104, 124, 144, and 164 are updated based on the training and differ from one client to the next because the training data is typically different at each of the clients 102, 122, 142, and 162.

When a training round at the clients 102, 122, 142, and 162 is completed, corresponding updates 108, 128, 148, and 168 are prepared and transmitted to the central server 180. The update 108 includes model weights 112 after local training and a predicted confidence 114 (a predicted confidence value). In one example, the predicted confidence 114 is an average predicted confidence value. The updates 128, 148, and 168 include, respectively, model weights 132, 152, and 172 and predicted confidences 134, 154, and 174.

FIG. 1B discloses additional aspects of selecting clients to participate in model aggregation. More specifically, FIG. 1B illustrates a phase two 182 that is performed at the server 180 after the server 180 receives the updates 108, 128, 148, and 168 from the clients 102, 122, 142, and 162. In phase two 182, the clients that will participate in the global model aggregation operation are selected. FIG. 1B also illustrates a phase three 184 in which a global model aggregation operation is performed using the updates of the selected clients.

In one example, the central server 180 uses the average predicted confidence values included in the updates 108, 128, 148, and 168 to select specific clients (or specific client updates) to use in the aggregation operation. For example, phase two 182 may select n clients from a set of C clients to participate in the aggregation operation. The clients are selected by comparing the predicted confidences to a threshold confidence value (threshold value) until the n clients are selected. In this example, n=3 and the threshold value may be, by way of example only, 0.1. Because the predicted confidences 114, 134, and 154 were above this threshold, the updates (or corresponding clients) 108, 138, and 148 are selected. The update 168 is excluded in this example because the predicted confidence 174 was below the threshold confidence and/or because the maximum number of clients had already been selected.

In another example, the n clients with the highest average predicted confidence values may be selected. In this example, the threshold confidence may also be enforced. This could potentially result in a situation where less than n clients are selected. However, for an initial round of training, the threshold may be set low. The threshold confidence for the next iteration or round may be changed (e.g., increased).

FIG. 1B also illustrates a phase three 184, which is also performed in the cloud at the central server 180. In this example, updates from the selected clients (updates 108, 128, and 148) are aggregated and applied to the current global model to generate a new (or updated) global model 186. The new global model 186 is then distributed back to all of the clients 188 in this example. Thus, clients that were selected and not selected in phase two 182 receive the new global model 186. The process then repeats by performing phase one 100. The clients selected for the next training round may differ from the currently selected clients. As previously indicated, federated learning is performed for multiple rounds/iterations until a stopping criterion is satisfied.

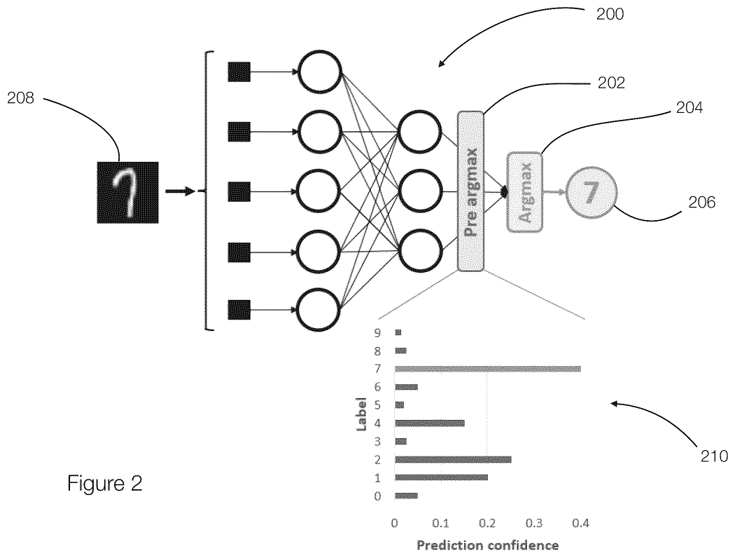

FIG. 2 discloses aspects of determining prediction confidence values in the context of local model training in federated learning systems. FIG. 2 illustrates an example of a local model 200. More specifically, federated learning typically begins by distributing an initialized global model to all participating clients. Thus, an initialized global model is distributed to each client c in a set of clients (C) or all c E C. Each of the clients then trains the now local model using local data.

FIG. 2 illustrates an example of a local model. By way of example only, the model 200 is trained using a local dataset. In this example, there are 10 possible classification labels (0-9) that may be output by the model 200. Thus, the input 208 is provided to the model 200 and an output label 206 or classification is generated/predicted. The output 206 is the label or classification with the highest prediction confidence value. The input 208, in this example, is a “7” and there are different confidences 210 for each potential label or classification. The argmax layer 204 selects the label with the highest prediction value as the prediction of the model 200. Thus, in FIG. 2, the predicted label would be “7” with a prediction confidence value of 0.4.

In one example of phase one, embodiments of the invention access the pre-argmax layer 202 and store the predicted confidence values associated with the layer 202 for all of the potential outputs or classifications. As the local training proceeds or ends, an average prediction confidence value may be generated and is associated with a confidence interval for each potential classification. This data (the average prediction confidence value and confidence interval) may be included in the update sent back to the central server such that specific clients can be selected. The updates of the selected clients are used in updating the global model.

More specifically, in one example, all prediction confidence values for each of the potential outputs/classifications are stored and averaged at the end of the training round.

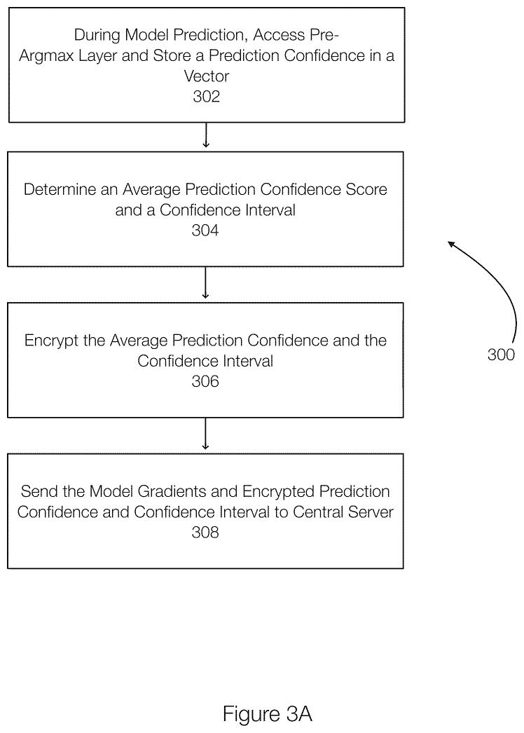

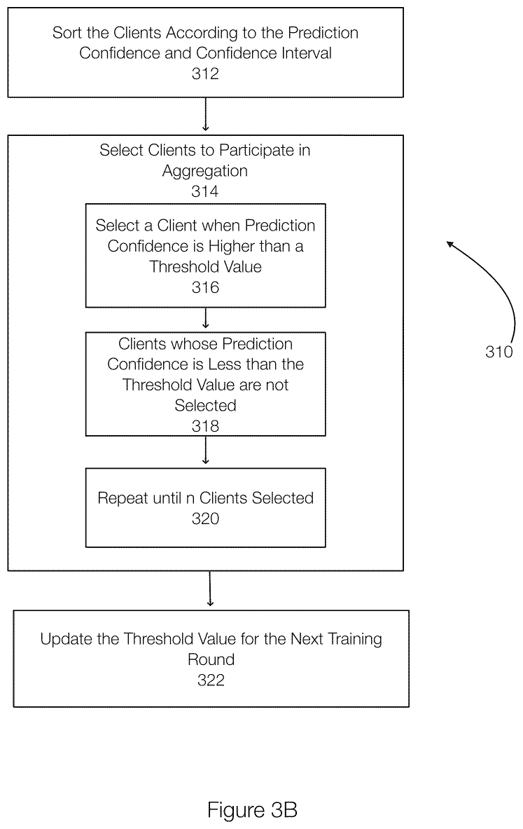

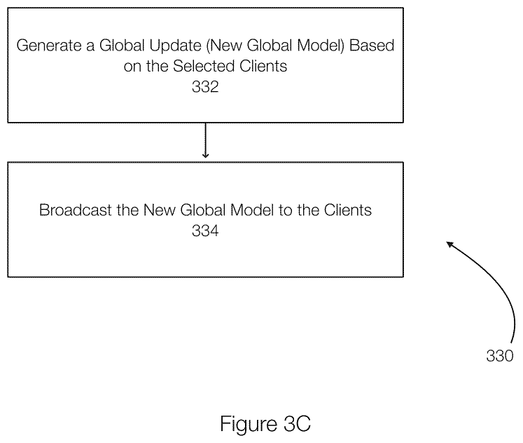

FIGS. 3A, 3B, and 3C disclose aspects of selecting clients whose updates contribute to global model aggregation in federated learning. FIG. 3A discloses aspects of a method for generating an update during a local training round at a client. The method 300 may be performed after a client receives an initialized global model or during each round/iteration of federated learning. Thus, each client in the federation begins a round with an initialized federated learning model trained with a set F of features.

At a client c, the method 300 is performed. During model prediction, the pre-argmax layer is accessed and a prediction confidence is stored 302 in a vector. Thus, the prediction confidence v_{c} is stored in a vector V_{c}. A confidence interval for the average predicted confidence value may also be generated and stored. Prediction confidence values (e.g., values 210) may be generated for each input into the model.

Once training or prediction is completed, an average prediction confidence score or value ((avg(V_{c})) is generated along with its confidence interval under a confidence level p. In one example, the confidence level is a user defined parameter that may range between 0 and 1 in one example.

Next the average prediction confidence value (E_{c}) and confidence interval 306 are encrypted 306. The model gradients (w_{c}), which may also be encrypted, and the encrypted average prediction confidence value (E_{c}) and/or confidence interval are sent 308 to the central server for global model aggregation.

FIG. 3B discloses aspects of a method for selecting clients to participate in global model aggregation at the central server. The method 310 may be performed at the central server after receiving updates from at least some of the clients. The updates include model updates (e.g., model weights) and an average predicted confidence value with a confidence interval. In the method 310, the clients are sorted 312 according to their average prediction confidence values (descending) and their confidence interval length (ascending) in order to prioritize clients with smaller confidence interval lengths when selecting clients for performing model aggregation.

More specifically, in one example, the lists of prediction confidence values and confidence interval length are aligned. They may be represented as a list of tuples containing two values: prediction confidence values and confidence interval lengths. The confidence interval length is used to consider such aspect when ordering the clients according the prediction confidence values. The priority for the ordering procedure is the prediction confidence and, if the prediction confidence are equal, the confidence interval lengths are considered. For example, if two clients (1 and 2) have equal prediction confidence values (e.g. 0.8) but client 1 has a larger confidence interval (e.g. +−0.2) than client 2 (e.g. +−0.1), client 2 will be prioritized (i.e., positioned first when compared with client 1).

Once the updates are sorted, clients are selected 314 to participate in a current round of global model aggregation. For each client, from the sorted or ordered list of clients, the average prediction confidence values are evaluated. If the prediction confidence value of a client is higher than a threshold value, the client is selected 316 to participate in the global model aggregation. When the prediction confidence value of a client is below the threshold value, the client is not selected 318 to participate in the current global model aggregation. This evaluation or process is repeated 320 while the number of selected clients is less than n. The selection process may end when n clients have been selected. The value of n may depend on the use case scenario, cloud/edge devices technical characteristics, the federated learning task, or the like. Next, the threshold value for the next training round is updated 322. For the first training round, the threshold value is typically close to 0 (near a lower end of the relevant range). In one embodiment, the threshold value is increased after each training round. In one example, the average prediction confidence value, in the context of the selected clients, may be determined and used to dynamically update the threshold value.

In one example, because the lists are sorted, the top n clients can be quickly selected.

FIG. 3C discloses aspects of model aggregation. In the method 330, after clients have been selected, the local model updates from the selected clients are aggregated and used to generate 332 a new global model. For example, the FedAVG algorithm may be used to create or generate the new global model for the federated learning system.

Next, the new (or updated) global model is broadcast 334 to all of the clients (both selected and unselected clients in one example). Advantageously, the labels of each client's datasets are not required, and the information used to select clients is encrypted, thereby assuring client privacy.

Embodiments of the invention use the pre-argmax layer to improve the federated learning/training process in a manner that does not heavily add to the computational/communication overhead in the federated learning system. This may be advantageous at least for use cases where edge devices may have resource constraints. In addition, an interpretable client selection mechanism (e.g., clients selected according to the predicted confidence values) allows users to determine or understand why their model update was selected or not selected. This may encourage clients or users to improve their local models and/or local data. Embodiments of the invention advantageously save time in obtaining a more accurate, reliable, and tailored aggregated global model suitable for the federated learning task.

In one experiment, embodiments of the invention were evaluated using a Flower framework (a specific framework for evaluating federated learning systems). In one example, experiments were conducted on an NMIST dataset and a heterogeneous federated learning scenario was simulated by controlling the data distributed to each client in the federation. Due to computational resource constraints, a small scenario including 15 clients was simulated and three MNIST data labels (the images referring to digits 1, 4 and 8) were selected. Clients 1 to 10 received data from all of these three labels and clients 11 to 15 received data from a specific label (only one of these labels). The server's testing dataset corresponded to the entire test set provided by the torchvision package (that is, it contains samples referring to all digits). In this manner, a scenario in a federated setting where some clients have less diverse datasets than others (heterogeneous) were simulated.

To test and validate the framework disclosed herein, a fully connected model was trained with three layers. The first layer has 28×28 output channels (the size of MNIST images), the second has 500, and the third has 10 channels (the number of total MNIST classes). On each device, the batch size is 32 and the epoch number is ten. The number of selected clients per round is 10 (n=10) and the prediction confidence threshold is initialized as 0.2 (t=0.2). After the first round, the average prediction confidence considering all selected clients was computed and the threshold was updated based on this average.

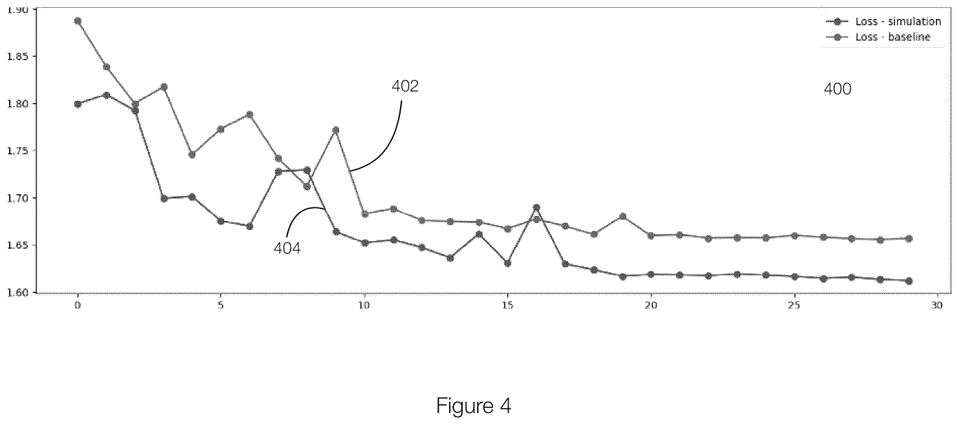

FIG. 4 discloses aspects of model loss using test data versus the communication rounds between clients and server using the MNIST dataset with embodiments of a client selection approach. The graph 400 illustrates a baseline 402 plot of loss versus a simulation 404 plot of loss. The baseline plot 402 is generated using a random client selection approach and the simulation plot 404 was generated using client selection methods disclosed herein.

The graph 400 summarizes convergence results for the model loss and compares a random client selection approach to a client selection approach as disclosed herein. As illustrated, embodiments of the invention have improved performed and faster convergence. Even considering a simple example scenario (10 clients, 3 classes, and only 30 communication rounds), using a better client selection approach, it is possible to notice that the loss obtained by embodiments of the invention are better than the loss obtained using the baseline approach.

The benefits of selecting clients for aggregation participation are likely to be even better when considering a larger scenario with more clients in the federation and more clients with less diverse datasets. Embodiments of the invention are more robust against such heterogeneous scenarios. However, in a homogeneous scenario where every client is exposed to highly similar datasets, a traditional federated learning system may present a similar performance. However, homogeneous scenarios are not common in real-world use cases and embodiments of the invention provide improved results.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, federated learning operations, global model aggregation operations, client selection operations, training operations, and the like or combination thereof. More generally, the scope of the invention embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data functionality for one or more clients. Another example of a cloud computing environment is one in which processing, data protection, and other services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers or VMs, or any combination of these, though no particular device implementation or configuration is required for any embodiment. Similarly, data storage system components such as databases, storage servers, storage volumes (LUNs), storage disks, for example, may likewise take the form of software, physical machines, containers, or virtual machines (VMs), though no particular component implementation is required for any embodiment.

As used herein, the term ‘data’ is intended to be broad in scope. Example embodiments of the invention are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: receiving an update from each client in a set of clients of a federated learning system for a current training round where each of the clients trained a local model using local data, wherein each of the updates includes a prediction confidence value and a model update, selecting clients from the set of clients based on the prediction confidence values included in the updates, generating a new global model using the model updates in the updates received from the selected clients, and sending the new global model to each of the clients in the set of clients.

Embodiment 2. The method of embodiment 1, wherein the prediction confidence values are average predicted confidence values generated by each of the clients over the current training round.

Embodiment 3. The method of embodiment 1 and/or 2, wherein the average confidence values are determined from outputs of a pre-argmax layer of the local model generated during the training round.

Embodiment 4. The method of embodiment 1, 2, and/or 3, wherein each of the average predicted confidence values are associated with a confidence interval, for each client.

Embodiment 5. The method of embodiment 1, 2, 3, and/or 4, further comprising sorting the clients based on the average prediction confidence values and/or the confidence intervals.

Embodiment 6. The method of embodiment 1, 2, 3, 4, and/or 5, further comprising selecting n clients whose average prediction confidence values are greater than a threshold value.

Embodiment 7. The method of embodiment 1, 2, 3, 4, 5, and/or 6, further comprising updating the threshold value after the training round for a next training round based on an average of the average predicted confidence values of the selected clients.

Embodiment 8. The method of embodiment 1, 2, 3, 4, 5, 6, and/or 7, wherein the clients selected from the current training round may differ from clients selected during a different training round.

Embodiment 9. A method comprising: performing federated learning in a federated learning system that includes a set of clients and a central server, wherein each training round includes a first phase, a second phase and a third phase, performing the first phase at each of the clients in the set of clients, wherein the first phase includes determining an average prediction confidence value and a confidence interval, performing the second phase at the central server, wherein the second phase includes selecting n clients from the set of clients whose average prediction confidence values are greater than a threshold value, performing the third phase at the central server, wherein the third phase includes aggregating local model updates received from the n clients and generating a new global model, and distributing the new global model to all of the clients in the set of clients and repeating the first phase, the second phase, and the third phase.

Embodiment 10. The method of embodiment 9, further comprising increasing the threshold value after each training round, wherein the training rounds are repeated until a loss converges or other stopping criteria is satisfied.

Embodiment 11. The method of embodiment 9 and/or 10, wherein the average prediction confidence values are generated from an output of a pre-argmax layer of the model.

Embodiment 12. The method of embodiment 9, 10, and/or 11, further comprising protecting privacy of the clients at least by encrypting at least the average prediction confidence values prior to transmission to the central server and wherein the local model updates comprise model weights.

Embodiment 13. A system, comprising hardware and/or software, operable to perform any of the operations, methods, or processes, or any portion of any of these, disclosed herein.

Embodiment 14. A non-transitory storage medium having stored therein instructions that are executable by one or more hardware processors to perform operations comprising the operations of any one or more of embodiments 1-12.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the terms module, engine, services, client, agent, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

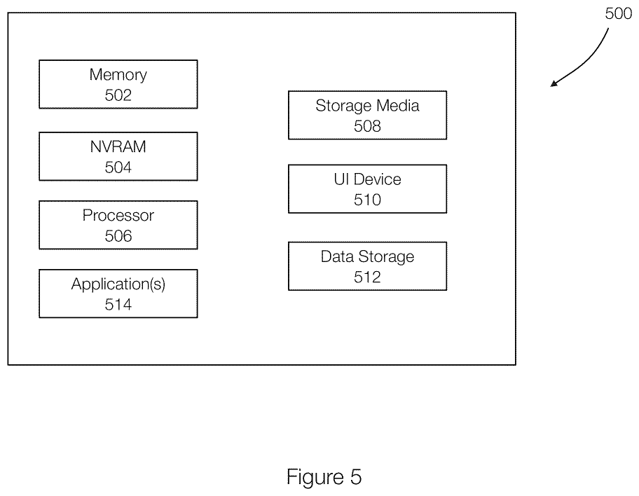

With reference briefly now to FIG. 5, any one or more of the entities disclosed, or implied, by the Figures, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving an update from each client in a set of clients of a federated learning system for a current training round where each of the clients trained a local model using local data, wherein each of the updates includes a prediction confidence value and a model update;
selecting clients from the set of clients based on the prediction confidence values included in the updates;
generating a new global model using the model updates in the updates received from the selected clients; and
sending the new global model to each of the clients in the set of clients.

2. The method of claim 1, wherein the prediction confidence values are average predicted confidence values generated by each of the clients over the current training round.

3. The method of claim 2, wherein the average confidence values are determined from outputs of a pre-argmax layer of the local model generated during the training round.

4. The method of claim 3, wherein each of the average predicted confidence values are associated with a confidence interval, for each client.

5. The method of claim 4, further comprising sorting the clients based on the average prediction confidence values and/or the confidence intervals.

6. The method of claim 2, further comprising selecting n clients whose average prediction confidence values are greater than a threshold value.

7. The method of claim 6, further comprising updating the threshold value after the training round for a next training round based on an average of the average predicted confidence values of the selected clients.

8. The method of claim 1, wherein the clients selected from the current training round may differ from clients selected during a different training round.

9. A non-transitory storage medium having stored therein instructions that are executable by one or more hardware processors to perform operations comprising:
receiving an update from each client in a set of clients of a federated learning system for a current training round where each of the clients trained a local model using local data, wherein each of the updates includes a prediction confidence value and a model update;
selecting clients from the set of clients based on the prediction confidence values included in the updates;
generating a new global model using the model updates in the updates received from the selected clients; and
sending the new global model to each of the clients in the set of clients.

10. The non-transitory storage medium of claim 9, wherein the prediction confidence values are average predicted confidence values generated by the clients over the current training round.

11. The non-transitory storage medium of claim 10, wherein the average confidence values are determined from outputs of a pre-argmax layer of the local model generated during the training round.

12. The non-transitory storage medium of claim 11, wherein each of the average predicted confidence values are associated with a confidence interval, for each client.

13. The non-transitory storage medium of claim 12, further comprising sorting the clients based on the average prediction confidence values and/or the confidence intervals.

14. The non-transitory storage medium of claim 10, further comprising selecting n clients whose average prediction confidence values are greater than a threshold value.

15. The non-transitory storage medium of claim 14, further comprising updating the threshold value after the training round for a next training round based on an average of the average predicted confidence values of the selected clients.

16. The non-transitory storage medium of claim 9, wherein the clients selected from the current training round may differ from clients selected during a different training round.

17. A method comprising:
performing federated learning in a federated learning system that includes a set of clients and a central server, wherein each training round includes a first phase, a second phase and a third phase;
performing the first phase at each of the clients in the set of clients, wherein the first phase includes determining an average prediction confidence value and a confidence interval;
performing the second phase at the central server, wherein the second phase includes selecting n clients from the set of clients whose average prediction confidence values are greater than a threshold value;
performing the third phase at the central server, wherein the third phase includes aggregating local model updates received from the n clients and generating a new global model; and
distributing the new global model to all of the clients in the set of clients and repeating the first phase, the second phase, and the third phase.

18. The method of claim 17, further comprising increasing the threshold value after each training round, wherein the training rounds are repeated until a loss converges or other stopping criteria is satisfied.

19. The method of claim 17, wherein the average prediction confidence values are generated from an output of a pre-argmax layer of the model.

20. The method of claim 17, further comprising protecting privacy of the clients at least by encrypting at least the average prediction confidence values prior to transmission to the central server and wherein the local model updates comprise model weights.
